(19) United States
(12) Patent Application Publication
(10) Pub. No.: US 2007/0166445 A1
(43) Pub. Date: Jul. 19, 2007

(54) Method for coloring beverages by means of light sources

(76) Inventor: Urban Ivano, Jesolo Lido (IT)

Correspondence Address: Inntek, Via Calnova 60, San Dona di Piave, Venezia, 30027, IT

(21) Appl. No.: 10/557,895

(22) PCT Filed: May 5, 2004
(86) PCT No.: PCT/EP04/50713

§ 371 Date: Nov. 22, 2005

(30) Foreign Application Priority Data
May 23, 2003 (IT) VE2003A000019

(51) Int. Cl. A23L 1/27

(52) U.S. Cl. 426/540

(57) ABSTRACT

This invention describes a methodology for coloring alimentary liquids such as alcoholic and soft drinks, in which electromagnetic irradiation in the field of vision is paradoxically used as a sole color source, optically perceptible in a homogenous way in a certain volume of liquid, by means of special physico-chemical characteristics artificially recreated in said liquid, placed in synergy with a luminous source present in the glass in which the beverage is to be served to the public. The present methodology applies a physical phenomenon known in scientific literature as the “Tyndall effect”, in which luminous diffusion deriving from a ray of light coinciding with particles in suspension is described.

### TECHNICAL FIELD

This invention describes a methodology for coloring alimentary liquids such as beverages, in which an electromagnetic irradiation in the field of vision is paradoxically used as the only color source, optically perceptible in a homogenous way in a certain volume of liquid by means of special chemical/physical characteristics artificially recreated in said liquid. The development of the present technology involves the use of electronic instruments and devices with special technical specifications, later described in detail.

### BACKGROUND ART

The techniques currently used for the artificial coloring of beverages is regulated by the World Institutes responsible for the control of food safety, which permits this practice only and exclusively through the use of special food additives classified as colorants and set out in the “positive list” compiled by said Institutes.

This special category of food additives have the sole function of creating the sensation of color in the aliment, a phenomenon perceived by the human eye on the basis of the spectral reflection of pigments contained in said additives.

The research carried out in the world patent archives to find the background art relative to technologies for coloring aliments in the liquid state has not shown any inventions that demonstrate significant analogies with this methodology.

### DISCLOSURE OF INVENTION

### Objectives of the Invention

To better understand the objectives that this technology is to establish, it should be remembered that the practice of coloring beverages is only and exclusively developed for marketing reasons, as in fact the consumer tends to perceive the typology and quality of a beverage on the basis of its coloring; if the drink is orange it means that it tastes of orange and the more intense the color the greater the quality.

Coloring food additives are also defined as non-active food additives, due to the fact that that they are completely useless from the alimentary point of view and given that the majority of these additives, not being natural products, are produced by means of chemical synthesis or biosynthesis.

Therefore, in this particular category of additives suspicions have arisen regarding toxicity for human beings, so much so that researchers from important World Institutes have developed toxicological tests, verifying many contra-indications to the prolonged ingestion of coloring additives produced using the aforementioned methods (for further information visit www.feingold.org—scientific research—food colorings and flavorings).

Moreover, the optical perception of the color and its shades decreases progressively with the reduction of the surrounding illumination, gradually losing that psycho-chromatic factor that induces a consumer to choose one drink over another.

The implementation of the present technology allows the following improvements to be achieved:
Coloring of drinks without any toxic contra-indications for human beings.
Increase in chromatic perception by reducing the level of surrounding illumination.
Possibility of applying the present technology to both alcoholic and soft drinks.

Possibility of using a wide range of colors with shades that are not obtainable using conventional methods.

As initially highlighted, the main aim of this technology is that of temporarily transferring, in a homogenous way to a certain volume of liquid, the chromatic properties irradiated from an artificial light source positioned adjacent to said liquid volume.

This proposal makes possible, by means of the implementation in the liquid of a physical phenomenon known in scientific literature as the “Tyndall effect”, which describes the diffusion of incident light with particles in suspension.

In order for the phenomenon to be implemented in a homogenous way in a certain volume of liquid and for this phenomenon to be perceived by the human eye, it is essential to place certain environmental conditions in close relation, such as the level of environmental light with the geometric characteristics of the container and the concentration of particles contained in the liquid with the light intensity of the electric device.

The method consists in artificially creating, in a certain volume of transparent liquid, a chemically heterogeneous system with phases made up of solid particles in stable or semi-stable suspension and in a sufficient quantity to create a certain degree of turbidity in the liquid; this liquid should be contained in a container with geometric features suitable for providing the volume of liquid with determined dimensions; this container should be equipped with an electric illuminating device with the luminous flux directed towards the opening of the container, the luminous intensity of said flux should be duly proportional to the absorbance/transmittance relation found in the liquid, to the chromatic properties irradiated by the luminous source and to the level of surrounding environmental illumination. The volumes of liquid taken into consideration for the application of this technology refer to doses commonly used for the administration of alcoholic and soft beverages that vary from 4 cl. for alcoholic drinks and 50 cl. for soft drinks.

Since the substances of concentration suitable for obtaining the aforementioned physico-chemical characteristics are considered as alimentary liquid, it is necessary to identify those recognized as having alimentary use, listed in the “positive list” compiled by the World Institutes responsible for controlling food safety.

The container or glass, used for the administration of a certain beverage, must have geometric features that provide dimensions, included between the following variables, to the entire volume of liquid contained in the container: height included between the radius value and the quadruple of this value.

To obtain the phenomenon claimed as a novelty to the background art, it is essential that an electric illuminating device, the luminous flow of which is directed towards the opening of the container, is present in the container intended for the administration of a pre-established drink.

The level of concentration of suspended solid particles present in the liquid is closely related to the following factors: the type of electromagnetic wavelength emitted by the luminous source, in relation to the energy absorption found in the particles dissolved in the liquid, and to the volume of liquid used.

Test Conditions:

In consideration of the type of industrial application to which this technology is addressed, the methodology adopted and the devices used for obtaining the reported data will be listed in the following tables A1-2-3-4, B1-2-3-4, C1-2-3-4, D1-2-3-4 enclosed with the present document, moreover it highlights that phenomenon is understood to mean a visible homogenous luminous irradiation visible in the entire volume of liquid.

Volume of the Transparent Liquid: the tests were conducted on liquid samples with a volume corresponding to the commercial dosage used for the administration of alcoholic and soft beverages to the public, including volumes of liquid that vary from a minimum of 4 cl. to a maximum of 50 cl.

Container Geometry: the containers used give form to the volumes of liquid taken into consideration for the test and have geometric parameters like those indicated in the previous description; height included between the radius value and the quadruple of this value.

Level of Turbidity: to create artificially the opacification in the transparent liquid a milk concentrate is used, containing 9% of fat matter and 22% of lactic non-fat dry extract, in a concentration that creates the necessary level of turbidity for the occurrence of the phenomenon. The aforementioned substances, used to obtain the level of turbidity in the transparent liquid, are to be considered only and exclusively as illustrative given that the level of turbidity necessary to obtain the phenomenon can be obtained with other substances included in the list of food additives compiled by Ministry of Health, such as clouding agents, emulsifiers, colorings, essential oils etc.

Reflection Coefficient: the concentration of substances used for the tests give the liquid a whitish color with a consequent high spectral reflection coefficient.

Luminous Intensity: the luminous source taken into consideration to carry out the test is the Light Emitting Diode (LED), at present seen as the most efficient system with equally efficient energy consumption. The LED, by which the best optical results are obtained, belongs to the “ultraluminous” category and is easily available on the market.

Luminous Flux: the LED's used to carry out the test have a lenticular diffuser that gives to the luminous source an optic angle included between 10/30 degrees. Due to the fact that volumes of liquid with small dimensions must be illuminated the data referring to the luminous flux reported in the tables set out below has been measured in “lux” at a distance of 100 [mm] from the luminous source.

Wavelength: the tests were carried out using luminous sources with polychromatic and monochromatic characteristics, subjected to the exclusive field of visibility.

Luminance of the Volume of Liquid: the synergy of the incident electromagnetic irrdiations with the solid particles in suspension in the volume of liquid causes a luminous diffusion effect, such as to give a luminosity to the entire volume of liquid apparently pertaining to the liquid; the data reported in the tables was measured with a luxmeter positioned adjacent to the container, orthogonal and perpendicular to the luminous flux.

Surrounding Illumination: this parameter serves to indicate the environmental illumination conditions with which the optical measurements were carried out adjacent to the container, orthogonal and perpendicular to the luminous flux.

Visual Evaluation of the Phenomenon: the phenomenon of liquid coloring is subordinated to the surrounding illumination coefficient, in the tables set out below the evaluations relating to the optical perception of the phenomenon with respect to the surrounding level of illumination are provided, “gradual loss of phenomenon” is understood to mean that the coloration of the liquid in the upper part is no longer visible, “sufficient phenomenon visibility” is understood to mean that the coloring in the liquid appears as non-uniform, “good visibility of the phenomenon” is understood to mean that the coloration of the liquid appears homogenous, “excellent visibility of the phenomenon” is understood to mean that the coloring of the liquid appears homogenous and with high colorimetric intensity.

Instrumentation Used: the lighting technology readings were executed with a luxmeter with a resolution equal to 0.1 lux and an approximate precision of ±5% rdg, at a color temperature of 2850K. The turbidity analyses were carried out with a nephelometer with an international metric scale (Nefelometric Turbidity Unit NTU).

Variables:

This study aims to specify phenomenon variability, that is the object of the present invention, to vary the parameters that concur with its manifestation; this variability is to be considered as the average deviation of the phenomenon with respect to the result obtained relating to the table requirements A1-2-3-4, B1-2-3-4, C1-2-3-4, D1-2-3-4. It is stated that the method undertaken for the aforementioned evaluation is based on experimental tests carried out one at a time varying only one variable and maintaining the others constant. Listed below are the practical observations deduced from these tests.

Container Geometry: the variation in container geometry, that is concretized with respect to the relation between rh<4r, practically involves the local deviations of the phenomenon including A15%.

Level of Turbidity: it has been observed that by increasing the degree of turbidity, always relative to the table conditions A1-2-3-4, B1-2-3-4, C1-2-3-4, D1-2-3-4, the proportional decrease of the phenomenon is produced, more precisely it can be said that in the immediate proximity of the luminous source the phenomenon remains constant while simultaneously in the upper part a complete disappearance of the phenomenon is observed. Then considering the description of the phenomenology subsequent to the decrease in the level of turbidity, it can be said that a clear non-uniformity of the phenomenon is manifested that is characterized by the implementation of the phenomenon orthogonally to the incident luminous flux and simultaneously by the accentuation of the phenomenon in the axial direction.

Reflection Coefficient: the dependence of the phenomenon on said coefficient is described briefly as a relation of the directly proportional type.

Wavelength: it is stated that the variations submit to the luminous visible field, with respect to this range it is found that by increasing the wavelength the phenomenon undergoes a slight decrease that can reach attenuation levels of up to 40%, while instead no relevant phenomenon changes are noted with respect to polychromatic irradiation.

Luminous Intensity: the dependence of the phenomenon on luminous intensity from the source is defined as almost linear.

Angle of Luminous Cone: significant alterations in the phenomenon are not found with variations of the apex angle included between −5°+15°.

Level of Luminance: for issues of instrumental practicality, the values are indicated in lux, measuring of said values being carried out perpendicularly and orthogonally with respect to the luminous flux behind the container. It is observed that the luminance value tends to increase when the volume of liquid is reduced, in short, this variable being of the type inversely proportional to the volume of liquid.

Level of Surrounding Environmental Illumination: this value is to be considered as a fundamental characteristic by those conducting the experiments. As it is possible to imagine, by increasing the level of surrounding illumination, the result is the corresponding decrease in the perception of the optical phenomenon, and obviously a more marked perception of the latter is obtained by reducing said level of illumination (see the optical phenomenon evaluations reported in the tables A1-2-3-4, B1-2-3-4, C1-2-3-4, D1-2-3-4).

### BRIEF DESCRIPTION OF THE DRAWINGS

16 Figures are enclosed with the present document, in which the tables A1-2-3-4, B1-2-3-4, C1-2-3-4, D1-2-3-4 are reported indicating the values obtained from the tests carried out on samples including volumes of liquid that vary from 4 to 50 cl.

In the aforementioned tests, illuminating devices called “LED” (Light Emitting Diode) have been taken into consideration, with an operating voltage varying from 1.9/5 volts and with energy consumption varying between 20/50 mAh, irradiating monochromatic (blue, green, red) and polychromatic light.

### BEST MODE FOR CARRYING OUT THE INVENTION

This technology is particularly suitable to be applied to a beverage that is to be administered in public premises that provide internal illumination with soft lighting such could as discotheques, nightclubs bars, pubs etc.

The application of the present technology, in addition to the elegant appearance that eliminates the use of coloring additives, produces a unique scenographic effect, so much so that it may give rise to the creation of a new sector of beverages purely indicated for nocturnal consumption.

### MODE FOR THE INVENTION

As already described in detail in the present document, in order for the beverage coloring phenomenon to be carried out, it is essential to know beforehand the type of drink, the quantity habitually served to the public and the luminous intensity irradiated by the electric device present in the glass in which the beverage is to be administered to the public.

The beverages most suitable for the application of the present technology are spirits and soft drinks, the industrial preparation of which imposes the turbidity value of the latter to be strictly considered, relating said value to the luminous intensity irradiated by the illuminating electric device that is to be used in the glass for the beverage that is to be served to the public.

It is possible to obtain long drinks with the ideal physico-chemical characteristics in order for the coloring phenomenon to be implemented provided that the composition of the mixture creates the correct liquid volume and turbidity conditions in relation to the luminous intensity irradiated by the electric illuminating device present in the glass.

The tables including all the necessary values for the repetition of the coloring phenomenon are enclosed with the present document, said phenomenon being obtained using illuminating devices supplied by batteries with protected buttons that guarantee coloring efficiency varying from 20/50 hours.

1. Methodology for coloring beverages obtained by applying the principles that determine luminous diffusion (Tyndall effect), Snell's law (geometric optics) and the Lambert-Beer Law (absorption photometry), this methodology mainly consists in providing a certain volume of alimentary liquid volume with chromatic properties irradiated from a light source adjacent to said volume of liquid.

2. Method for coloring beverages, according to claim 1 characterized in that, in the container in which a certain drink is to be served, an electric illuminating device emitting light in the field of vision is included.

3. Method for coloring beverages, according to claim 2 characterized in that, the luminous flux irradiated by the luminous source must be directed towards the opening of the container.

4. Method for coloring beverages, according to claim 2 characterized in that, the container in which a certain drink is to be served to the public, has geometric features in order to provide dimensions, included between the following variables, to the entire volume of liquid: height included between the radius value and the quadruple of said value.

5. Method for coloring beverages according to claim 1 characterized in that, in the transparent liquid a chemically heterogeneous system has been artificially created with phases made up of solid particles in stable or semi-stable suspension.

6. Method for coloring beverages, according to claim 5 characterized in that, the level of concentration of solid particles suspended in the transparent liquid creates a certain level of turbidity.

7. Method for coloring beverages, according to claim 5 characterized in that the concentration level of the suspended solid particles is subordinated to the type of electromagnetic wavelength emitted by the luminous source.

8. Method for coloring beverages, according to claim 5 characterized in that the concentration level of the suspended solid particles is subordinated to the absorbance/transmittance relation found in the suspended solid particles dissolved in the liquid.

9. Method for coloring beverages, according to claim 5 characterized in that the concentration level of the suspended solid particles is subordinated to the volume of liquid used.

10. Method for coloring beverages, according to claim 5 characterized in that, since it is an alimentary liquid, the suitable concentration substances for achieving the chemical/physical characteristics indicated must be identified in the “positive list” of food additives compiled by World Health Institutes organized for this function.

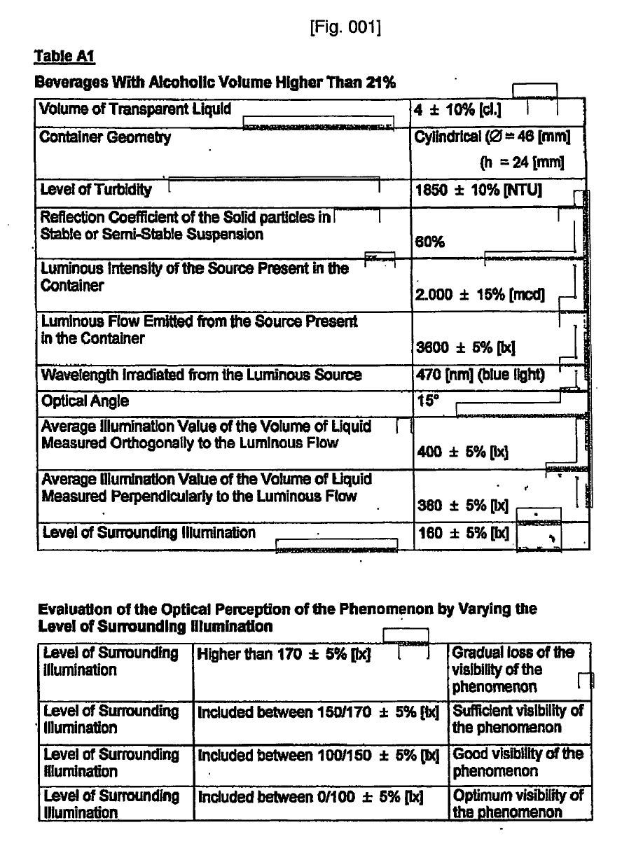

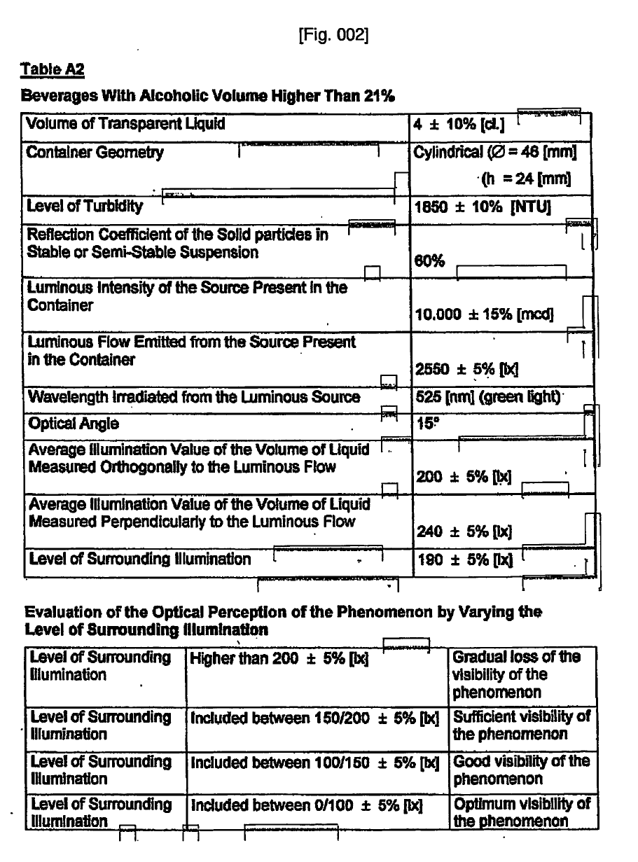

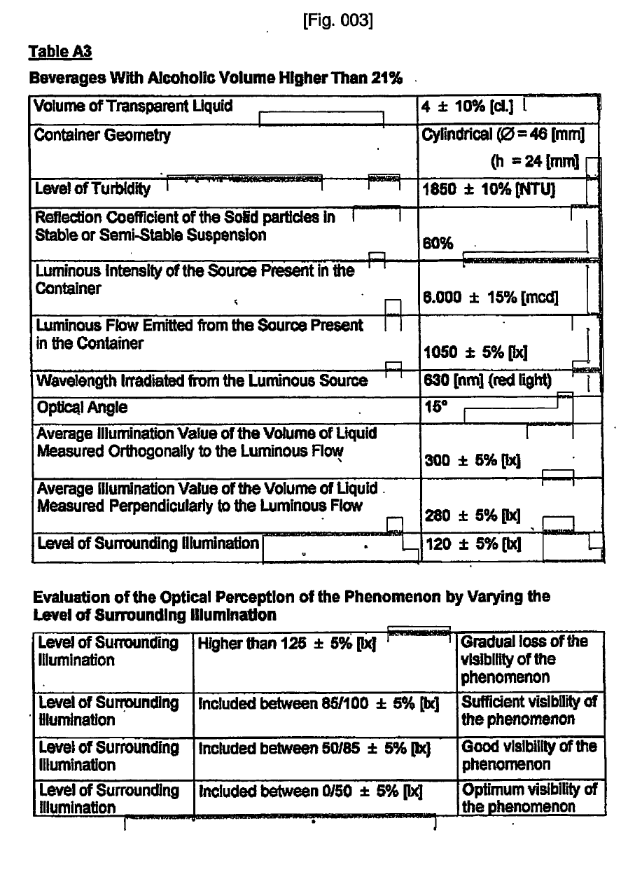

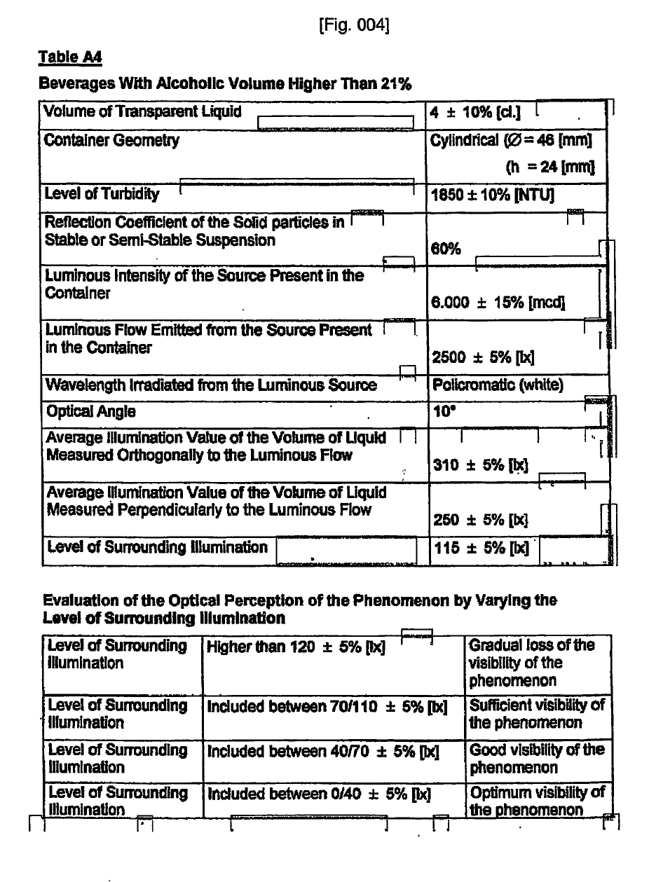

11. Method for coloring beverages, according to claim 1 characterized in that, for beverages served to the public in doses of about 4 [cl.], the parameters to be followed in order for the phenomenon to occur are reported in the enclosed FIG. 1/16-2/16-3/16-4/16, (table A1-2-3-4).

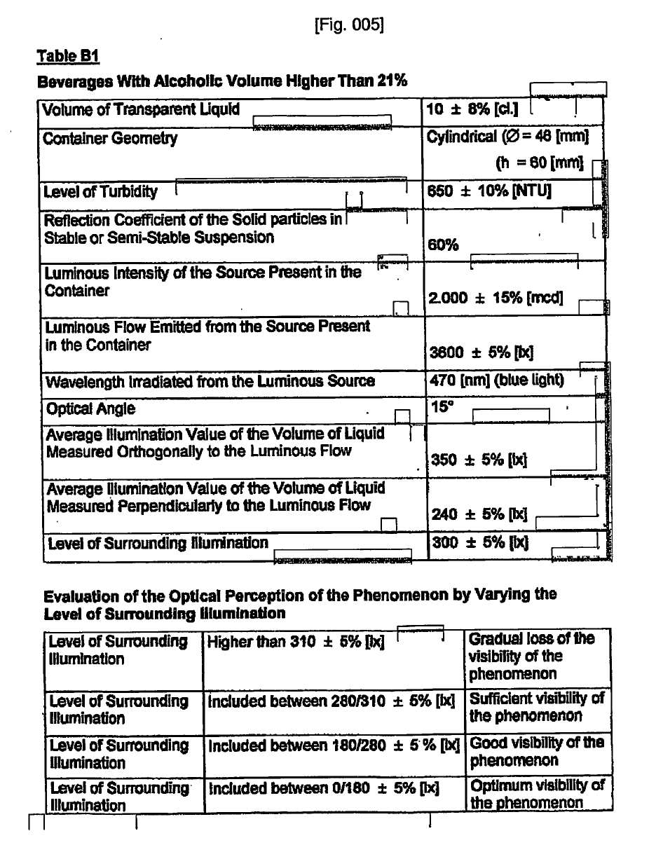

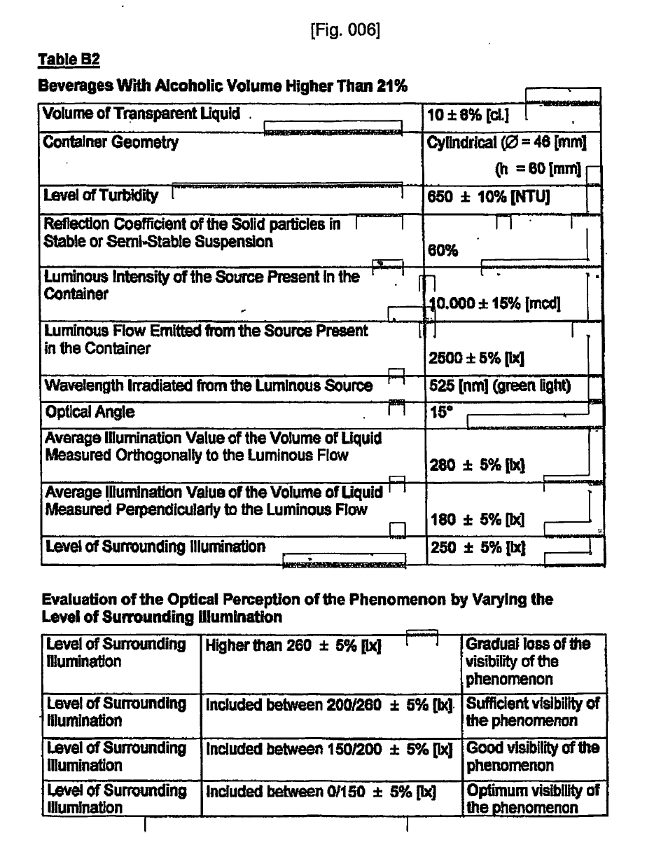

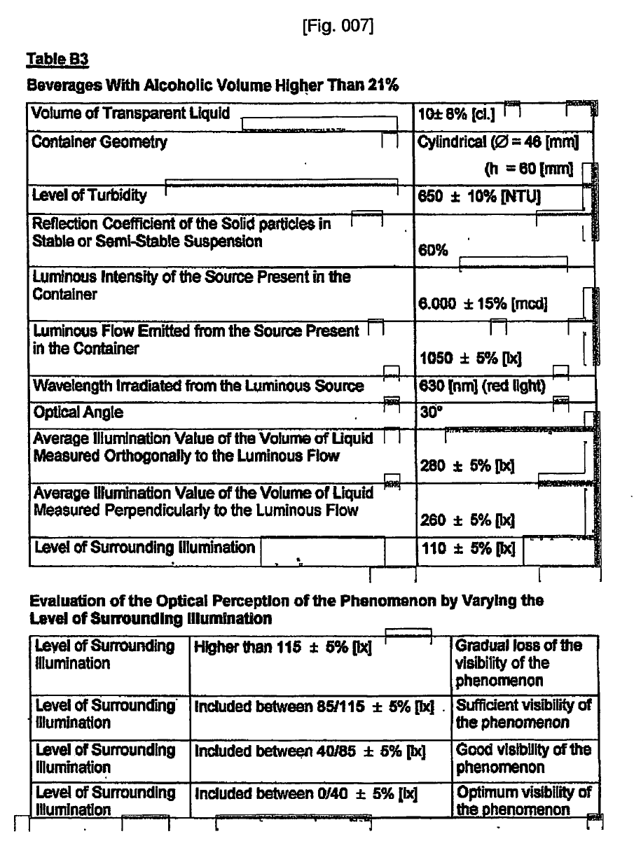

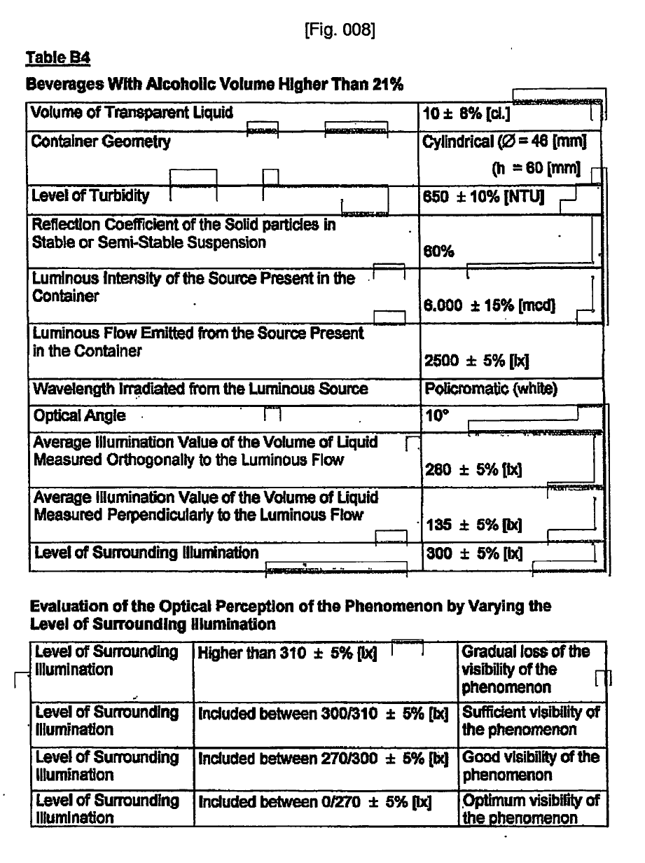

12. Method for coloring beverages, according to claim 1 characterized in that, for beverages served to the public in doses of about 10 [cl.], the parameters to be followed in order for the phenomenon to occur are reported in the enclosed FIG. 5/16-6/16-7/16-8/16, (table B1-2-3-4).

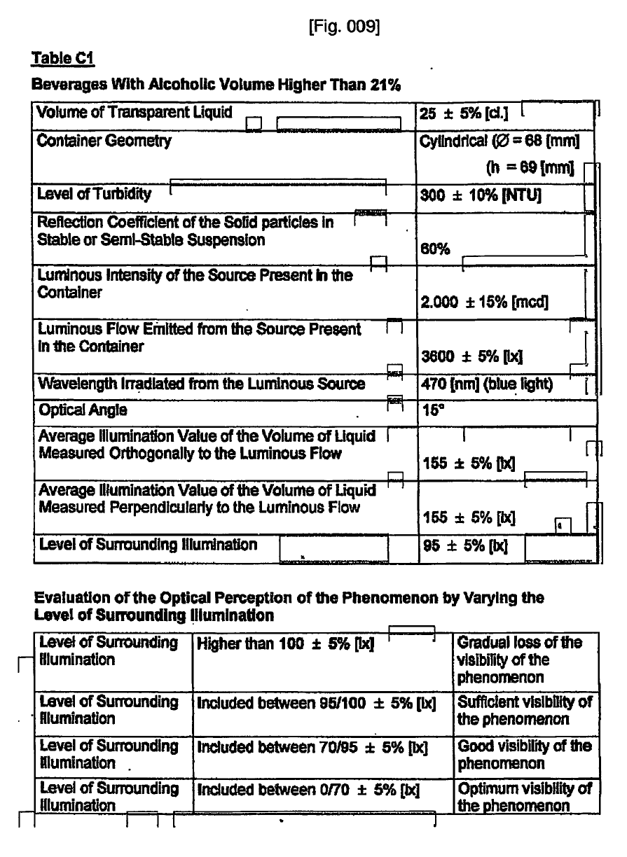

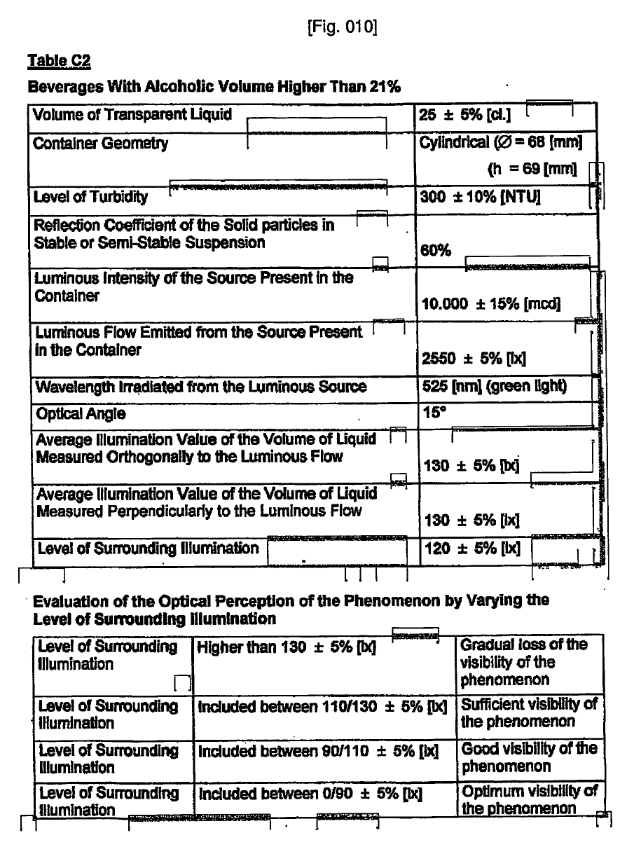

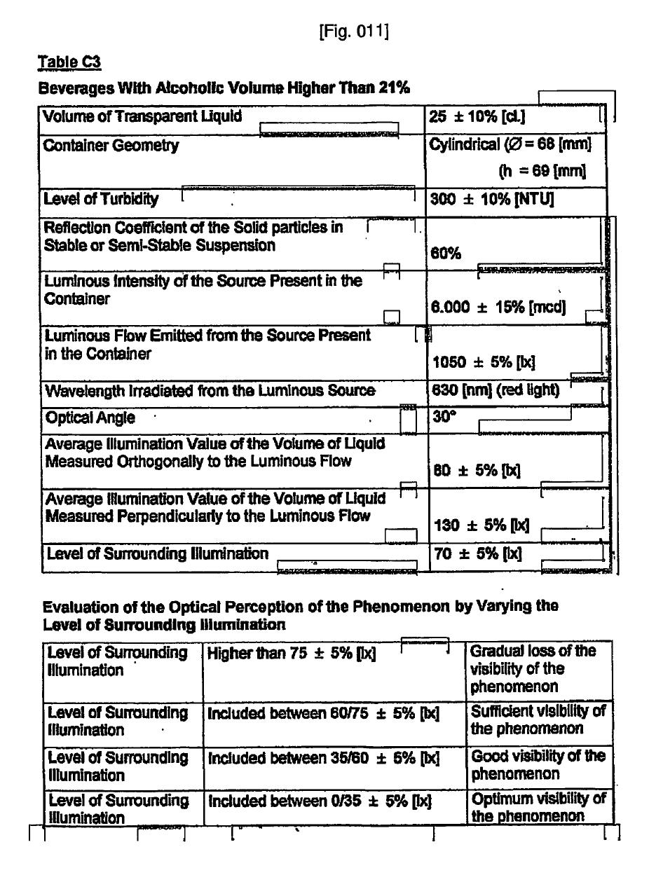

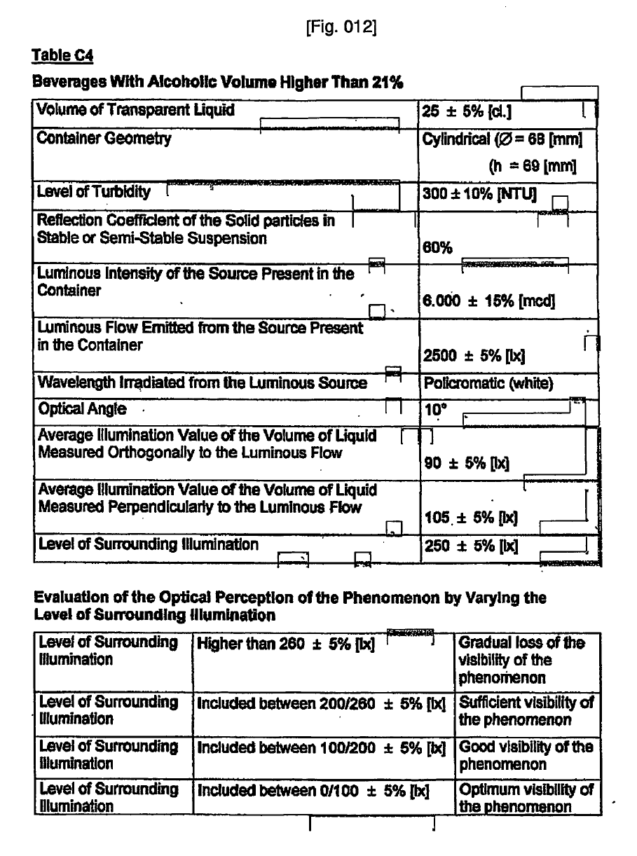

13. Method for coloring beverages, according to claim 1 characterized in that, for beverages served to the public in doses of about 25 [cl.], the parameters to be followed in order for the phenomenon to occur are reported in the enclosed FIG. 9/16-10/16-11/16-12/16—(table C1-2-3-4).

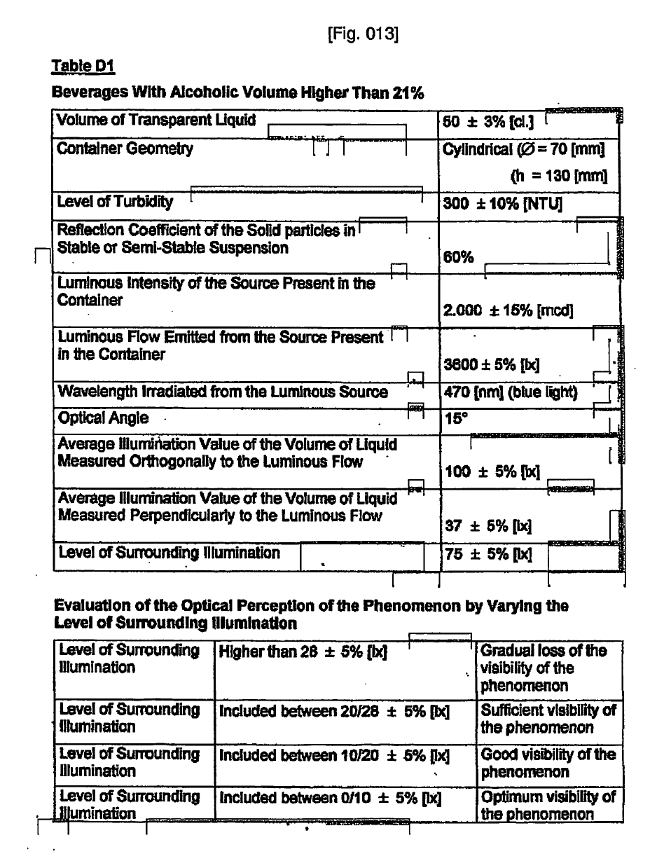

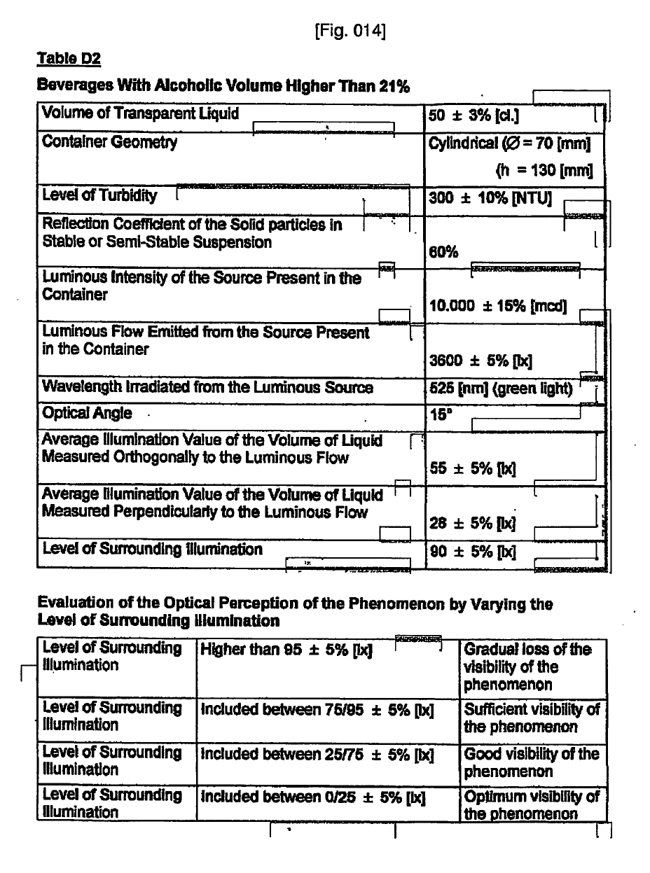

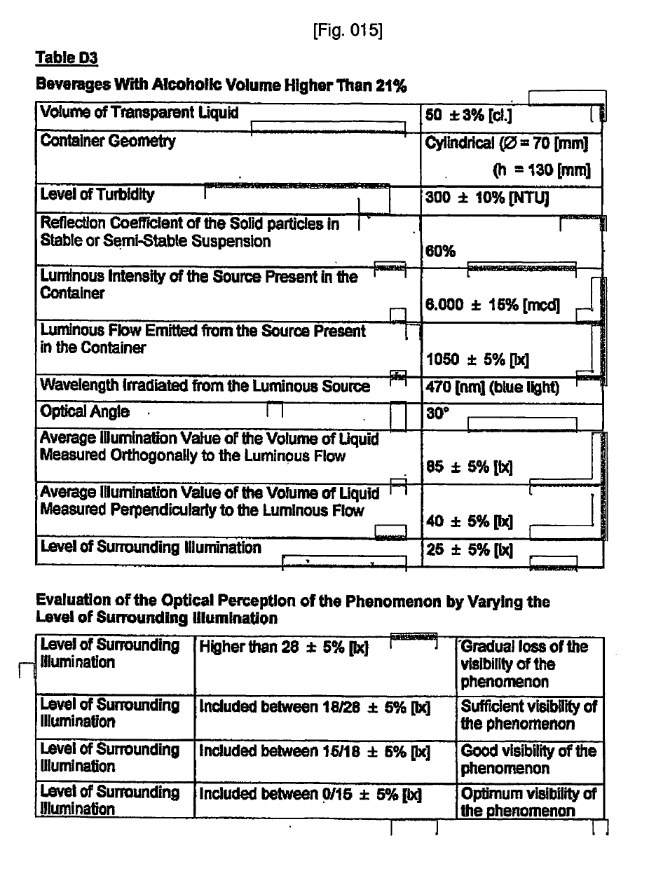

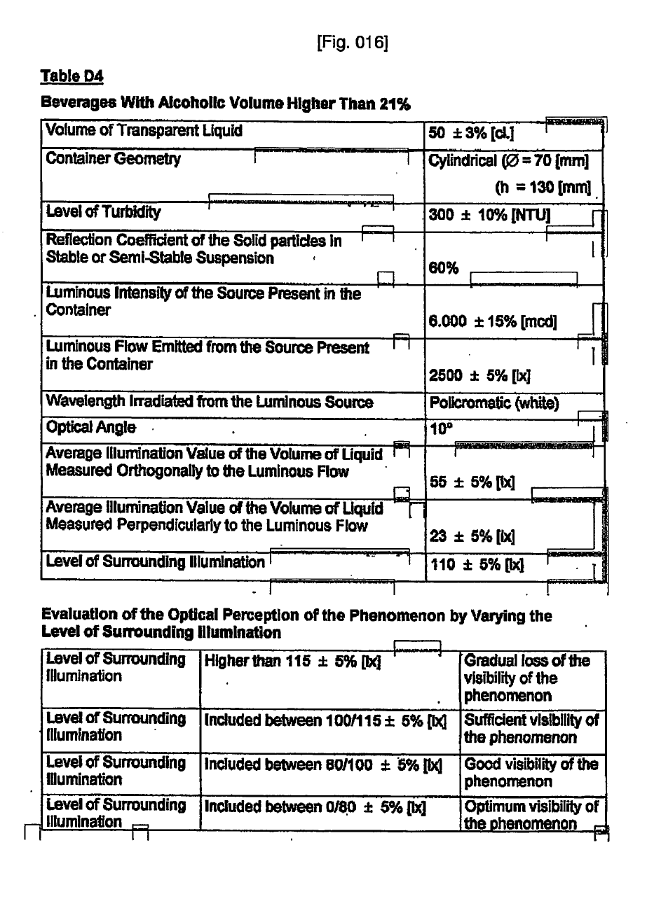

14. Method for coloring beverages, according to claim 1 characterized in that, for beverages served to the public in doses of about 4 [cl.], the parameters to be followed in order for the phenomenon to occur are reported in the enclosed FIG. 13/16-14/16-15/16-16/16, (table D1-2-3-4).

15. Method for coloring beverages, according to claim 11, 12, 13, 14, characterized in that, in the tables A1-2-3-4, B1-2-3-4, C1-2-3-4, D1-2-3-4, reported in the enclosed FIG. 1/16-2/16-3/16-4/16-5/16-6/16-7/16-8/16-9/16-10/16-11/16-12/16-13/16-14/16-15/16-16/16, maintaining the parameters constant, by varying the geometry of the container, included between the radius value and the quadruple of the latter value, a notable variation of the measured phenomenon A15% is obtained.

16. Method for coloring beverages, according to claims 11, 12, 13, 14, characterized in that, in the tables A1-2-3-4, B1-2-3-4, C1-2-3-4, D1-2-3-4, included in the enclosed FIG. 1/16-2/16-3/16-4/16-5/16-6/16-7/16-8/16-9/16-10/16-11/16-12/16-13/16-14/16-15/16-16/16, maintaining the parameters constant, by increasing the level of turbidity, a proportional decrease in the visibility of the phenomenon is obtained.

17. Method for coloring beverages, according to claims 11, 12, 13, 14, characterized in that, in the tables A1-2-3-4, B1-2-3-4, C1-2-3-4, D1-2-3-4, included in the enclosed FIG. 1/16-2/16-3/16-4/16-5/16-6/16-7/16-8/16-9/16-10/16-11/16-12/16-13/16-14/16-15/16-16/16, maintaining the parameters constant, by reducing the level of turbidity a non-uniformity in the phenomenon is manifested characterized by the attenuation of the latter orthogonally to the incident luminous flux and simultaneously with an accentuation of said phenomenon in the axial direction.

18. Method for coloring beverages, according to claims 11, 12, 13, 14, characterized in that, in the tables A1-2-3-4, B1-2-3-4, C1-2-3-4, D1-2-3-4, included in the enclosed FIG. 1/16-2/16-3/16-4/16-5/16-6/16-7/16-8/16-9/16-10/16-11/16-12/16-13/16-14/16-15/16-16/16, maintaining the parameters constant, by varying the reflection coefficient found in the particles dissolved in the liquid, a directly proportional variation of the phenomenon is obtained.

19. Method for coloring beverages, according to claims 11, 12, 13, 14, characterized in that, in the tables A1-2-3-4, B1-2-3-4, C1-2-3-4, D1-2-3-4, included in the enclosed FIG. 1/16-2/16-3/16-4/16-5/16-6/16-7/16-8/16-9/16-10/16-11/16-12/16-13/16-14/16-15/16-16/16, maintaining the parameters constant, the use of monochromatic luminous sources included in the visible electromagnetic spectrum with wavelengths higher than 470 [nm] produces the progressive decrease of luminance in the entire volume of liquid.

20. Method for coloring beverages, according to claims 11, 12, 13, 14, characterized in that, in tables A1-2-3-4, B1-2-3-4, C1-2-3-4, D1-2-3-4, included in the enclosed FIG. 1/16-2/16-3/16-4/16-5/16-6/16-7/16-8/16-9/16-10/16-11/16-12/16-13/16-14/16-15/16-16/16, maintaining the parameters constant, the use of polychromatic luminous sources determines improvements to the optical variations of the phenomenon.

21. Method for coloring the drinks, according to claims 11, 12, 13, 14, characterized in that, in the tables A1-2-3-4, B1-2-3-4, C1-2-3-4, D1-2-3-4, included in the enclosed FIG. 1/16-2/16-3/16-4/16-5/16-6/16-7/16-8/16-9/16-10/16-11/16-12/16-13/16-14/16-15/16-16/16, maintaining the parameters constant, the dependence of the phenomenon on the intensity of the luminous source contained in the container is defined as almost linear.

22. Method for coloring beverages, according to claims 11, 12, 13, 14, characterized in that, in the tables A1-2-3-4, B1-2-3-4, C1-2-3-4, D1-2-3-4, included in the enclosed FIG. 1/16-2/16-3/16-4/16-5/16-6/16-7/16-8/16-9/16-10/16-11/16-12/16-13/16-14/16-15/16-16/16, maintaining the parameters constant, by varying the apex angle of the luminous cone to −5° and +15° significant phenomenon variations are not noted.

23. Method for coloring beverages, according to claims 11, 12, 13, 14, characterized in that, in the tables A1-2-3-4, B1-2-3-4, C1-2-3-4, D1-2-3-4, included in the enclosed FIG. 1/16-2/16-3/16-4/16-5/16-6/16-7/16-8/16-9/16-10/16-11/16-12/16-13/16-14/16-15/16-16/16, maintaining the parameters constant, by raising the value of the parameter relative to the level of surrounding environmental illumination, a proportional loss of the optical perception of the phenomenon is produced.

24. Method for coloring beverages, according to claims 11, 12, 13, 14, characterized in that, in the tables A1-2-3-4, B1-2-3-4, C1-2-3-4, D1-2-3-4, included in the enclosed FIG. 1/16-2/16-3/16-4/16-5/16-6/16-7/16-8/16-9/16-10/16-11/16-12/16-13/16-14/16-15/16-16/16, maintaining the parameters constant, by decreasing the value relative to the level of surrounding environmental illumination, a proportional accentuation of the optical perception of the phenomenon is produced.

25. Method for coloring beverages, according to claims 11, 12, 13, 14, characterized in that, in the tables A1-2-3-4, B-2-3-4, C1-2-3-4, D1-2-3-4, included in the enclosed FIG. 1/16-2/16-3/16-4/16-5/16-6/16-7/16-8/16-9/16-10/16-11/16-12/16-13/16-14/16-15/16-16/16, maintaining the parameters constant, the value of the luminance level of the entire volume of liquid, measured orthogonally and perpendicularly to the luminous source, tends proportionally to increase by reducing the volume of liquid.

26. Method for coloring beverages, according to claims 11, 12, 13, 14, characterized in that, in the tables A1-2-3-4, B1-2-3-4, C1-2-3-4, D1-2-3-4, included in the enclosed FIG. 1/16-2/16-3/16-4/16-5/16-6/16-7/16-8/16-9/16-10/16-11/16-12/16-13/16-14/16-15/16-16/16, the parameters for the evaluation of the optical perception of the phenomenon that is the object of this invention are indicated.
